(19) United States
(12) Patent Application Publication
(10) Pub. No.: US 2008/0267756 A1
(43) Pub. Date: Oct. 30, 2008

(54) Robot Comprising a Horizontal Linear Axis with a Movable Carriage and Joint Arm

(75) Inventors: Wolfgang Echelmeyer, Osterholz-Scharmbeck (DE); Hermann Franck, Ritterhude (DE); Eckhard Wellbrock, Bremen (DE); Jorg Rosenhager, Bielefeld (DE)

Correspondence Address: EDWARD W. GOEBEL, JR.;MACDONALD, ILLIG, JONES & BRITTON LLP, 100 STATE STREET, SUITE 700, ERIE, PA, 16507-1498, US

(73) Assignee: ROTHENBERGER, S.A.

(21) Appl. No.: 12/067,544

(22) PCT Filed: Jun. 30, 2006
(86) PCT No.: PCT/DE2006/001136

§ 371 Date: May 19, 2008

(30) Foreign Application Priority Data
Sep. 23, 2005 (DE) 10 2005 047644.9

(51) Int. Cl. B25J 9/02; B65G 15/30

(52) U.S. Cl. 414/749.1; 198/804; 901/30

(57) ABSTRACT

The invention relates to a robot, comprising a horizontal linear axis with a movable carriage and a joint arm, the one end of which is connected to one of the ends of the carriage by means of a rotating joint in the direction of travel thereof, characterized in that the joint arm may rotate in a plane at an angle α in the range of 45° to 90° to the horizontal and at least two joint arm pieces which may rotate relative to each other in said plane and with an effector, provided at the free moving end of the outer joint arm.

The present invention relates to a robot comprising a horizontal linear axis with a movable carriage and a joint arm, whose one end is connected by means of a rotary joint to one of the two ends of the carriage in the movement direction thereof, as well as a device for loading and/or unloading unit loads for transportation vehicles or containers horizontally accessible from at least one side, with a conveyor movable or telescopable into the transportation vehicle or container and with a robot movable into the transportation vehicle or container and a device for storing and/or removing unit loads for high-bay facilities, with a conveyor movable up to or into or telescopable high-bay facility and with a robot movable up to or into the high-bay facility. A linear axis can e.g. be a driven linear guide system.

The term unit loads means everything which can be transported in package form, i.e. which is not liquid or gaseous. Liquids and gases in containers (e.g. barrels or gas cylinders) do in fact constitute unit loads. Unit loads can have parallelepiped-like, rotating body-like and complicated shapes and also include containers, e.g. on a container ship.

Transportation vehicles can e.g. be lorries, trucks, railway freight cars, ships, aircraft, etc. The exemplified containers are frequently elongated, box-shaped transportation and storage areas for unit loads.

In distribution centres of logistic service providers the incoming unit loads are unloaded with the aid of unloading devices for unit loads of the aforementioned type and are also largely automatically distributed. For this purpose conveyors with conveyor belts are frequently used and are moved gradually into the interior of a container and the unit load stored in the container is placed by means of a robot on the conveyor belt and then the unit load is conveyed away by said conveyor belt. The robot is moved together with the conveyor or at the same time with the latter into the container. Such robots have an optical detection system for identifying individual unit loads and an effector e.g. in the form of a gripping device, which successively grips the unit loads and placed the same on the conveyor belt. This type of unloading is relatively complicated and therefore time consuming, because the robots used are normally positioned in the container laterally or upstream of the end of the conveyor belt and consequently following the gripping of the unit load must rotate in the direction of the downstream conveyor belt side and only following this can deposit the unit load on the conveyor belt.

The aforementioned problem also arises in the case of devices for storing and removing unit loads in connection with a high-bay facility and in general terms with devices for transferring or transloading unit loads.

Therefore the problem of the invention is to permit a faster transferring or transloading, particularly loading and/or unloading and storing and/or removing unit loads than has hitherto been possible.

In the case of a robot of the aforementioned type, this problem is solved by the invention in that the joint arm is rotatable in a plane which is at an angle α in the range 45 to 90° to the horizontal and at least two joint arm pieces, which are rotatable relative to one another in said plane, and comprising an effector provided at the freely movable end of the outer joint arm piece. The effector can e.g. be a gripper, such as e.g. a clamping or suction gripper, but also a finger or a type of hand or fork for raising a unit load.

The problem is also solved by a robot according to claim 3.

Moreover, in the case of a device for loading and/or unloading unit loads of the aforementioned type, the problem is solved in that the robot is placed in an elevated position over the conveyor.

In the case of the device for storing and/or removing unit loads for high-bay facilities of the aforementioned type, this problem is solved in that the robot is placed in an elevated position over the conveyor.

With the robot according to claim 1, the plane can be at an angle α in the range 45 to 90° to the carriage movement direction.

In a special embodiment of the robot according to claim 3 the base is a carriage of a linear axis.

The side of the base can also be under an angle α in the range 45 to 90° to the horizontal.

In particular, the side of the base can be under an angle α in the range 45 to 90° to the base movement direction.

Advantageously the ends are connected in a substantially triangle form to the base.

Advantageously the angle α is in the range 60 to 90°.

In particular, the angle α can be 90°.

Advantageously the linear axis is in multitrack construction form.

Appropriately the linear axis comprises a gear drive mechanism.

In the case of the devices for loading and/or unloading and for storing and/or removing unit loads, the conveyor advantageously comprises a conveyor belt.

Advantageously there is a bridge spanning the conveyor belt and the robot is mounted on the bridge. Obviously the bridge can be replaced by a bracket or the robot can instead be mounted on a roof, ceiling or on the top of a building opening.

Advantageously the bridge is movable heightwise. This provides a seventh axis, so that the at least two-part joint arm can move up to specific singular positions through an axial configuration, which could otherwise not be achieved by specific geometrical or mathematical boundary conditions.

Appropriately the fixing point of the joint arm piece is movable horizontally at right angles to the conveyor belt on the bridge.

Advantageously the robot is mounted on the top or bottom side of the central part of the bridge.

According to another special embodiment of the invention the bridge can be moved into the transportation vehicle or container independently of the conveyor belt or the front end of the conveyor belt.

It is alternatively possible to mount the bridge on a trolley, which is movable together with the conveyor belt or the front end of the conveyor belt into the transportation vehicle or container. The trolley can e.g. be coupled to the outer end of the conveyor belt.

It is also conceivable for the robot to have a joint arm rotatable in a horizontal plane and comprising at least two joint arm pieces, which are rotatable relative to one another in said horizontal plane.

Advantageously the robot is in accordance with one of the claims 1 to 11.

The invention is based on the surprising finding that through the provision of the robot in an elevated position over the conveyor belt it is able to grip the unit load e.g. with a gripper and place it directly on a conveyor belt through which it can be conveyed away. There is no need for additional robot pivoting and rotating movements. This e.g. permits a faster loading and/or unloading and storing/removal of unit loads.

Moreover, through the robot according to the invention and in a particularly simple manner rapid loading and/or unloading or storing and/or removing of unit loads is facilitated, because e.g. in the case of containers the complete rectangular cross-section can be covered.

The robots have in all at least six movable axes, so that unit loads in a container can be gripped in any possible position.

Further features and advantages of the invention can be gathered from the claims and the following description of several embodiments with reference to the attached diagrammatic drawings, wherein show:

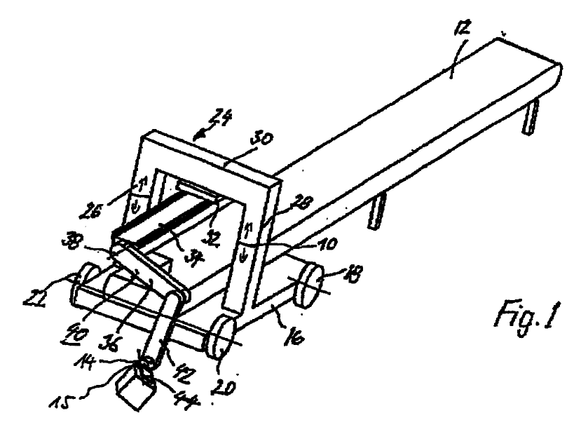

FIG. 1 A perspective view of a device for unloading unit loads according to a special embodiment of the invention at the instant of gripping a package in the interior of a not shown container.

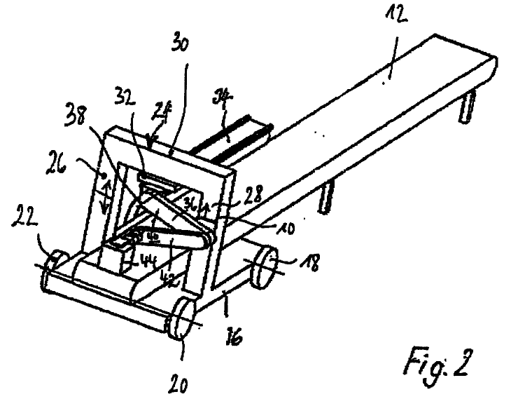

FIG. 2 A corresponding view at the instant of placing the package on a conveyor belt.

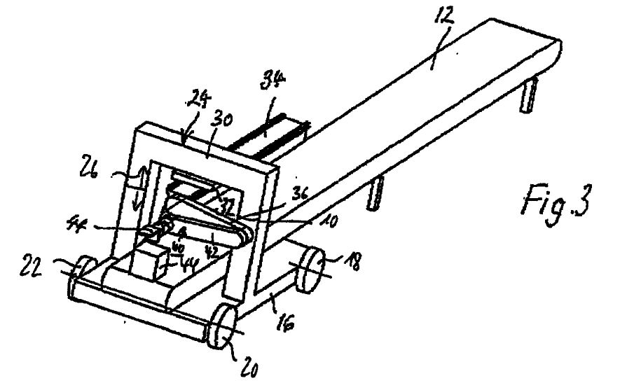

FIG. 3 A corresponding view of the situation after releasing the package on the conveyor belt.

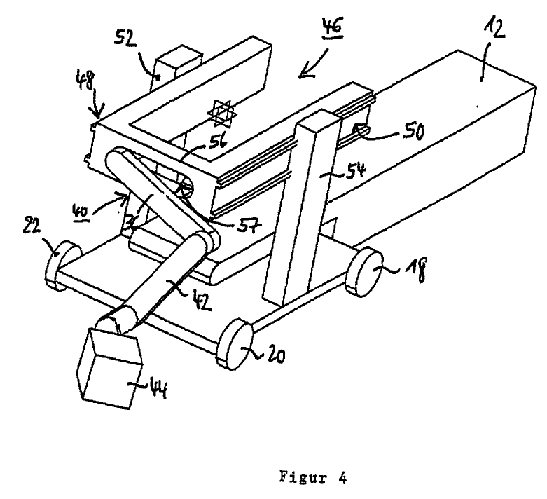

FIG. 4 A perspective view of an unloading device according to another special embodiment of the invention.

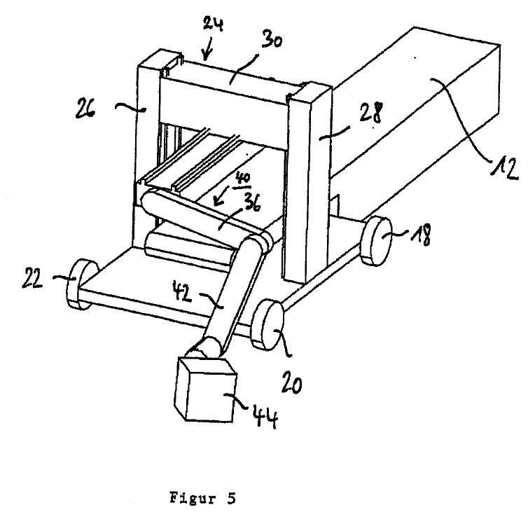

FIG. 5 A perspective view of an unloading device according to a further special embodiment of the invention.

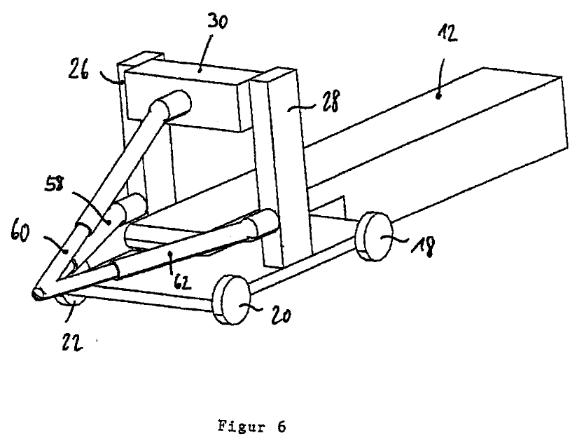

FIG. 6 An unloading device according to a further special embodiment of the invention.

FIG. 1 shows an unloading device according to a special embodiment of the invention in an arrangement in which it is introduced into a not shown container, which in all the drawings is considered to be bottom left. The unloading device comprises a conveyor belt 12, which with the aid of a not shown telescoping device can be introduced in the longitudinal direction in a box-shaped, elongated container from the front side thereof. Thus, the conveyor can continuously change its length in accordance with the progressing discharging process. In association with the front end of the conveyor 10 a trolley 16 is provided, which is movable with the aid of rollers 18, 20, 22 in the longitudinal direction of the container interior. Trolley 16 can be connected to the front end of conveyor 10 or can in some other way have its movement synchronized with the advancing conveyor 10.

The trolley 16 carries a bridge, which bridges the conveyor 12 in the form of an inverted U. The bridge carries the reference numeral 24 and comprises vertical side members 26, 28, whose upper ends are connected by a cross-member 30. The bridge 24 can change height with the vertical movement device 10.

Beneath the cross-member 30 is fixed a guide 32, on whose underside is longitudinally displaceably guided a carriage 34. Said carriage 34 carries on its front end facing the viewer in FIG. 1 a two-part joint arm 36, which is rotatable about an axis 38 parallel to conveyor belt 12, i.e. in a plane under a not shown angle α of 90° to the horizontal and to the movement direction of carriage 34. Joint arm 36 comprises a first joint arm piece 40 and a second joint arm piece 42, which is rotatable in the vicinity of the outer end of the first joint arm piece 40 about a not shown axis running parallel to conveyor belt 12. At the end of the second joint arm piece 42 are successively located the rotary axis 14 and the not shown rotary axis 15, axis 14 being parallel to the rotation axis of the second joint arm piece 42 and axis 15 is at a right angle thereto. At the outer end of the rotary axis 15 is provided a gripper 44, which makes it possible to grip unit loads, as can be seen in FIG. 1.

Thus, gripper 44 can cover the entire cross-sectional surface of the not shown container and through the movement of carriage 34 each position in the longitudinal direction of the container or conveyor belt 12 can be reached. Thus, components 32, 34, 36, 42, 14, 15 and 44 form a robot.

FIGS. 1 to 3 illustrate in a number of steps the gripping of unit loads located in the container and the placing thereof on conveyor belt 12. On passing from the position of FIG. 1 to that of FIG. 2, carriage 34 has moved back into its retracted position, where the gripper 44 is above conveyor belt 12. Gripper 44 can now release the package and lift it upwards as shown in FIG. 3. The package can now be conveyed out of the container by conveyor belt 12.

In place of guide 32 with carriage 34 it is also possible to provide on bridge 24 a robot, which has a three-dimensionally movable gripper.

The embodiment shown in FIG. 4 differs from the embodiments of FIGS. 1 to 3 in that in place of guide 32 and carriage 34 guided in guide 32 there is a two-track guide profile 46 comprising two horizontal guide profiles 48 and 50, which are externally guided in in each case laterally positioned, vertical side members 52, 54 and interconnected by a horizontal cross-member 56 on the side of the front end of conveyor belt 12, the first joint arm piece 40 being fixed in rotary manner in a vertical plane to the cross-member 56. The fixing point of joint arm piece 40 is movable in an elongated hole 57 extending horizontally in cross-member 56. Thus, the seventh axis is horizontal and at right angles to the conveyor belt.

The embodiment shown in FIG. 5 differs from that of FIGS. 1 to 3 essentially in that only cross-member 30 is heightwise movable.

Finally, the embodiment shown in FIG. 6 differs from that of FIGS. 1 to 3 in that in place of the guide 32, carriage 34 and joint arm pieces 40 and 42 telescopable arms 58, 60, 62 are hingedly fixed to the bridge 30 substantially in the form of a triangle, i.e. a telescopable arm 58 by its one end to side member 26, one end of telescopable arm 60 in the centre of cross-member 30 and one end of telescopable arm 62 to side member 28 and the other ends of the telescopable arms 58, 60, 62 are interconnected and equipped with a not shown, common effector. The telescopable arms 58, 60, 62 are located on that side of the bridge which is directed into the interior of the not shown container. Through differing extension of the telescopable arms, it is not only possible to cover a specific plane, but even a volume in the not shown container, so that as a result the complete container can be unloaded. Thus, components 58, 60 and 62, as well as the gripper form a robot.

Obviously the robots also have suitable drives and controls and the latter can also be remote therefrom.

The features of the invention disclosed in the present description, drawings and claims can be essential to the implementation of the invention in its different embodiments both singly and in random combinations.

### REFERENCE NUMERALS LIST

10 Conveyor
12 Conveyor belt
14, 15 Rotary axes
16 Trolley
18, 20, 22 Rollers
24 Bridge
26, 28 Side members
30 Cross-member
32 Guide
34 Carriage
36 Joint arm
38 Axis
40, 42 Joint arm pieces
44 Gripper
46 Two-track guide profile
48, 50 Guide profiles
52, 54 Side members
56 Cross-member
57 Elongated hole
58, 60, 62 Telescopable arms

1. Robot comprising a horizontal linear axis with a movable carriage (34) and a joint arm (36), whose one end is connected by means of a rotary joint to one of the two ends of the carriage (34) in the movement direction thereof, characterized in that the joint arm (36) is rotatable in a plane which is at an angle α in the range 45 to 90° to the horizontal and at least two joint arm pieces (40, 42), rotatable relative to one another in said plane, and comprising an effector located on the freely movable end of the outer joint arm piece (42).

2. Robot according to claim 1, characterized in that the plane is at an angle α in the range 45 to 90° to the movement direction of carriage (34).

3. Robot comprising a horizontally movable base and at least three telescopable arms (58, 60, 62) whose one ends are hingedly connected to the base on one side in the base movement direction and whose in each case other ends are interconnected and equipped with a common effector.

4. Robot according to claim 3, characterized in that the base is a carriage (34) of linear axis (46).

5. Robot according to claim 3, characterized in that the side of the base is under angle α in the range 45 to 90° to the horizontal.

6. Robot according to claim 2, characterized in that the side of the base is an angle α in the range 45 to 90° to the base movement direction.

7. Robot according to claim 3, characterized in that the in each case one ends are connected substantially in triangle form to the base.

8. Robot according to claim 3, characterized in that the angle α is in the range 60 to 90°.

9. Robot according to claim 3, characterized in that angle α is 90°.

10. Robot according to claim 3, characterized in that the linear axis has a multi-track construction.

11. Robot according to claim 3, characterized in that the linear axis comprises a gear drive mechanism.

12. Device for loading and/or unloading unit loads for transportation vehicles or containers horizontally accessible from at least one side, with a conveyor (10) movable or telescopable into the transportation vehicle or container and with a robot movable into the transportation vehicle or container, characterized in that the robot is placed in an elevated position over the conveyor (10).

13. Device according to claim 12 for storing and/or removing unit loads with respect to high-bay facilities, with a conveyor (10) movable up to or into or telescopable with respect to the high-bay facility and with a robot movable up to or into the high-bay facility, characterized in that the robot is placed in an elevated position over the conveyor (10).

14. Device according to claim 12, characterized in that the conveyor (10) comprises a conveyor belt (12).

15. Device according to claim 14 characterized in that a bridge (24) spanning the conveyor belt (12) is provided and the robot is mounted on the bridge (24).

16. Device according to claim 14, characterized in that the bridge (24) is movable height wise.

17. Device according to claim 14, characterized in that the fixing point of the joint arm piece (36) is movable horizontally and at right angles to conveyor belt (12) on bridge (24).

18. Device according to claim 17, characterized in that the robot is mounted on the underside of the central part of bridge (24).

19. Device according to claim 18, characterized in that the bridge (24) is movable into the transportation vehicle or container independently of conveyor belt (12) or the front end of conveyor belt (12).

20. Device according to claim 18, characterized in that the bridge (24) is mounted on a trolley, which is movable into the transportation vehicle or container together with the conveyor belt (12) or the front end of conveyor belt (12).

21. Device according to claim 20, characterized in that the robot has a joint arm (36), which is rotatable in a horizontal plane and comprises at least two joint arm pieces rotatable relative to one another in said horizontal plane.

22. Device according to claim 20, characterized in that the robot is in accordance with claim 11.
